(19) United States
(12) Patent Application Publication
(10) Pub. No.: US 2021/0383414 A1
(43) Pub. Date: Dec. 9, 2021

(54) CUSTOMER ENGAGEMENT SYSTEM AND METHOD

(71) Applicant: Everseen Limited, Blackpool (IE)

(72) Inventors: Alan O'Herlihy, Glenville (IE); Joe Allen, Ballybunion (IE); Bogdan Ciubotaru, Donoughmore (IE); Mark Ibbotson, Bentonville, AR (US); Razvan-Dorel Cioarga, Oradea (RO); Raymond Hegarty, Dublin (IE); Margaret Hartnett, Dublin (IE)

(21) Appl. No.: 17/335,431

(22) Filed: Jun. 1, 2021

(30) Foreign Application Priority Data
Jun. 3, 2020 (GB) 2008375.4

(51) Int. Cl. G06Q 30/02

(52) U.S. Cl. CPC G06Q 30/0201

(57) ABSTRACT

A customer engagement method comprises detecting a location and moving a suspended aerial robotic device to the customer's location, detecting one or more characterizing features of the customer and greeting the customer by the suspended aerial robotic device based on the detected characterizing features, presenting a menu of items to the customer and requesting the customer to identify items of interest receiving an order for identified items from the customer, retrieving the items corresponding to the placed order from a repository containing stock items, releasing the retrieved items to the suspended aerial robotic device, requesting touchless payment from the customer by the suspended aerial robotic device, and releasing the retrieved items by the suspended aerial robotic device to the customer on receipt of touchless payment by the customer.

### TECHNICAL FIELD

The present disclosure generally relates to a customer engagement method and system. More specifically, the present disclosure relates to a touchless customer engagement method and system.

### BACKGROUND

While the decline in high-street retail in recent years has been well-documented, recent months of the coronavirus pandemic have been cataclysmic for the retail sector. Having been initially overrun by hordes of panic-buyers intent on stockpiling groceries and pharmaceuticals, stores were then shuttered at the behest of government lockdown orders. For those stores allowed to remain open, social distancing rules have seen queues of shoppers formed outside as they wait to be allowed in to do their shopping.

Governments are gradually relaxing lockdown measures to allow more stores to open subject to strict social distancing restrictions. These restrictions are likely to remain in force for the foreseeable future. Thus, retail outlets will need to be significantly re-purposed to allow them to continue to serve their customers while reducing viral spread. In an age of virtually assisted touchlessness, repurposing a venue to comply with social distancing rules will prove prohibitively expensive for many. As a consequence, future revenues in this sector may be primarily driven by delivery, drive-through, and takeout modalities.

Indeed, as customers exercise caution about where, what and how they make their purchases, the previously ongoing shift to contactless delivery of meals, groceries, and products of all kinds is likely to accelerate. Similarly, as customers venture less into public places and spend less time there, marketers must find new ways to reach and communicate with their customers.

### SUMMARY

In a first aspect of the present disclosure, there is provided a customer engagement method. The method comprises the steps of detecting a location of a customer, detecting one or more characterizing features of the customer, moving a suspended aerial robotic device to the customer's location, greeting the customer in accordance with the one or more characterizing features, presenting a menu of items to the customer, requesting the customer to identify items of interest from the menu, receiving from the customer an order placed towards one or more items, retrieving the items corresponding to the placed order from a repository containing stock items, releasing the retrieved stock items to the suspended aerial robotic device, requesting touchless payment from the customer for the placed order, and releasing the retrieved stock items to the customer on receipt of touchless payment by the customer for the order. In the method disclosed herein, the suspended aerial robotic device performs the steps of greeting the customer, receiving the order from the customer, requesting the touchless payment from the customer, and releasing the items to the customer.

In a second aspect of the present dislcosure, a customer engagement system comprises a customer detection module adapted to process video information received from one or more sensors to determine the location of a customer and detect one or more characterizing features of the customer. Further, the customer engagement system includes a customer interaction module adapted to use the characterizing features to create a customized greeting message and issue the greeting message to the customer. Furthermore, the customer engagement system includes an order taking module adapted to receive from the customer an order placed by the customer for one or more items. Still further, the customer engagement system includes a repository control module adapted to retrieve the one or more items corresponding to the placed order from a repository of stock items. Further, the customer engagement system comprises a billing and payment module adapted to request the customer for payment for the placed order and to use a contactless card reader unit to receive the payment from the customer. The customer engagement system also includes a gripping means adapted to hold one or more stock items retrieved by the repository control module and release the retrieved one or more stock items to the customer on receipt of contactless payment. In the customer engagement system, the customer interaction module, the order taking module, the billing and payment module and the gripping means are operable by a suspended aerial robotic device in which the suspended aerial robotic device is movable to the customer's location to receive the customer's order, the repository to pick up the one or more stock items retrieved by the repository control module, return to the customers location to receive payment for the placed order, and release the picked up one or more stock items corresponding to the placed order to the customer.

In a third aspect of the present disclosure, embodiments are also directed towards a non-transitory computer readable medium having computer-executable instructions stored thereon. These computer-executable instructions when executed by a processor cause the processor to perform functions consistent with that of the method disclosed herein.

The customer engagement system and method can deliver a quick service restaurant (QSR) facility and retailer services to a customer in a parked care or in any outdoor space. Through its use of speech recognition, gesture recognition and advanced aerial robotics, the customer engagement system and method provides a highly interactive environment which significantly increases opportunities for retailers and marketers to engage with customers to deliver goods retailer services in environs where this was previously very limited if not impossible. More specifically, the customer engagement system and method can deliver drive-though QSR and retail services to customers while they are outside of the retail premises. For example, in the retailers' carpark or on a street during a festival or at a sporting event. The customer engagement system and method effectively turns any open space into a drive-thru experience.

The customer engagement system and method can deliver and demonstrate product samples to a customer and thereafter conduct a brief survey on the product sample just delivered. This enables the real time collection and analysis of the results of customer surveys, to support detailed demographic and geographic variables in assessing the likelihood of a trial product's future success. In particular, the customer engagement system provides opportunities for the issuance of promotion messages to customers while they are waiting for their order to be completed. Indeed, the customer engagement system enables a retailer to work with its consumer product goods partners to modify both how, when and why promotional and other marketing tactics and strategies are deployed. This could involve samples that historically were offered in-store or simply handed out at the entrance of stores, wherein the customer engagement system now opens the entire store parking lot as the venue.

Furthermore, since the customer engagement system and method is operable with fixed and mobile goods repositories, pop-up stores (including vans loaded with stock items) can employ the infrastructure provided by the user engagement system and method to access a wider audience than they could otherwise reach. Furthermore, while the customers are waiting in their vehicles for receipt of their ordered items, the customers represent a captive audience that marketers can readily tap into to assess new product ideas.

Similarly, since social distancing rules mean that patrons are likely to be waiting outside buildings more than before, the customer engagement system and method is operable to support routine interactions with a patron normally conducted prior to a more detailed engagement with the patron. For example, the user engagement system and method is operable to support the collection of basic patient information (name, address, age, insurance policy number (if appropriate) and pre-existing conditions etc.) from a patient while they are waiting outside a medical facility to be called inside for a medical consultation.

Furthermore, the customer engagement system and method is not limited to outdoor settings. In particular, the user engagement system and method is also operable in an indoor setting, wherein the suspended aerial robotic device is effectively suspended from the ceiling; and is adapted to detect the entry of a customer into a building or a zone of a building. For example, the customer engagement system and method is operable to request a customer what product items they want to buy; and to guide the customer to the location(s) in the store that house the product item(s) of interest identified by the customer. Alternatively, the customer engagement system and method is operable to assist customers (and store operators) in checkout and self-checkout zones, to offer guidance to customers regarding a next required step in their interaction with a self-checkout device, or to advise store operators of self-checkout devices where a customer needs assistance.

It will be appreciated that features of the present disclosure are susceptible to being combined in various combinations without departing from the scope of the present disclosure as defined by the appended claims.

### BRIEF DESCRIPTION OF DRAWINGS

Several embodiments of the disclosure are herein described by way of example only with reference to the accompanying drawings in which:

FIG. 1 is a block diagram of the hardware components of the customer engagement system in accordance with the second aspect of the present disclosure;

FIG. 2 is a diagrammatic view of an aerial host element of a front-end module of FIG. 1;

FIG. 3 is a block diagram of a back-end module of the customer engagement system of FIG. 1;

FIG. 4 is a block diagram of the software components of the customer engagement system of the first aspect of the present disclosure, distinguishing between front-end software components and back-end software components by respective swim-lane representations;

FIG. 5 is a flowchart of the method of customer engagement of the first aspect of the present disclosure; and

FIG. 6 is a side elevation view of an exemplary use case of the customer engagement system of the third aspect of the present disclosure.

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

While certain specific features are illustrated in the above figures, those skilled in the art will appreciate from the present disclosure that various other features have not been illustrated for the sake of brevity and so as not to obscure more pertinent aspects of the implementations disclosed herein.

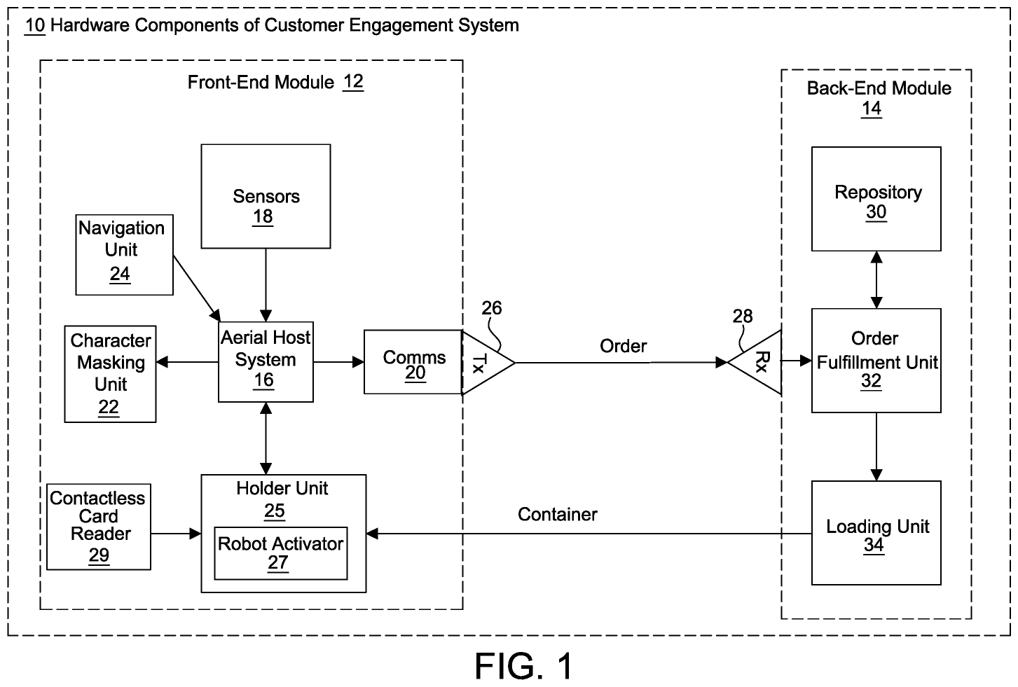

The customer engagement system of the preferred embodiment comprises a plurality of functionally integrated hardware and software components. Referring to FIG. 1, the hardware components 10 comprise a front-end module 12 and a back-end module 14. The front-end module 12 is adapted to engage with a customer. The back-end module 14 is adapted to maintain a store of goods (or access to a body of services) and to supply the goods (and/or services) to the customer on receipt of a request therefor.

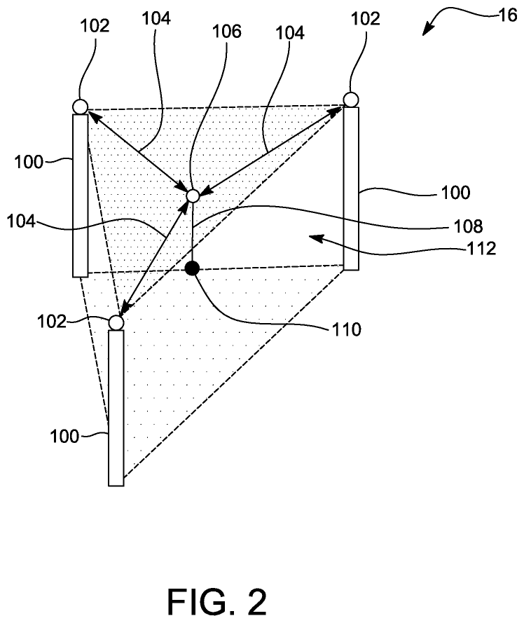

To this end, the front-end module 12 comprises an aerial host system 16 communicatively coupled with one or more sensors 18, a first communications unit 20, a character masking unit 22, a navigation unit 24 and a contactless card reader unit 29 (or radio frequency tag reader or a near field tag reader). Referring to FIG. 2, the aerial host system 16 comprises a plurality of upright members 100, each of which is drivable at least partly into the ground. An elevated anchor point 102 is mounted on each upright member 100 at substantially the same height from the ground. Each elevated anchor point 102 comprises an electric stepper motor (not shown) which in turn includes a rotor (not shown). Each rotor is coupled with a first end of a wire 104 which is arranged so that the rest of the wire 104 is at least partly wrapped around the rotor. The other end of each wire 104 is coupled with a carrier device 106. The carrier device 106 itself houses at least one electric motor (not shown) each of which includes a rotor (not shown). The rotor is coupled with a first end of a wire 108 which is arranged so that the rest of the wire 108 is at least partly wrapped around the rotor. A suspended aerial robotic device 110 is suspended from the other end of the wire 108.

Thus, the wires 104, upright members 102 and the ground effectively define a volume 112 within which the suspended aerial robotic device 110 is housed and is capable of being moved. The carrier device 106 is adapted to be moved through the activation of the electric motors at the anchor points 102 to cause the wire 104 coupled to each electric motor to be further wound or unwound from the electric motor's rotor, thereby shortening or lengthening each such wire 104. The suspended aerial robotic device 110 is adapted to move through the activation of the electric motor(s) in the carrier device 106 to cause the wire 108 coupled to each electric motor to be further wound or unwound from the electric motor's rotor, thereby shortening or lengthening the wire 108. Collectively, the electric stepper motors (not shown) in the elevated anchor points 102 and the carrier device 106 operate under the control of the navigation unit (not shown) to permit the controlled movement of the suspended aerial robotic device 110 from a first location to a second location within the volume 112.

Looking at FIG. 1 together with FIG. 2, the sensor 18 in the front-end module 12 may comprise one or more video sensors (e.g. video camera), an audio sensor and one or more proximity sensors. The navigation unit 24 which permits controlled navigation and movement of the suspended aerial robotic device 110 may be housed within the carrier device 106 or may be located remotely and communicatively coupled with the aerial host system 16 through a communications interface (not shown).

The first communications unit 20 may comprise an antenna unit (not shown) to permit communication with a remotely located cell phone or other wireless device. The first communications unit 20 may also comprise a speaker (not shown), a display unit (not shown) and a microphone (not shown) respectively adapted to issue an audible message or to display a message to a customer and to receive a communication from the customer. The first communications unit 20 may also comprise a transmitter unit 26 communicatively coupled with a corresponding receiver unit 28 in the back-end module 14. In this way, the first communications unit 20 is adapted to transmit the communication received from the customer to the back-end module 14.

The character masking unit 22 adapted to present a visually appealing, non-threatening persona for the suspended aerial robotic device 110. For example, the character masking unit 22 may comprise a projector unit (which may include a holographic display unit) adapted to display an avatar of a popular animation, movie, computer game or comic-book character (e.g. a superhero). Alternatively, the character masking unit 22 may comprise a physical model of the relevant character (e.g. a toy or action figure).

The suspended aerial robotic device 110 may be mechanically and communicatively coupled to a holder unit 25. The holder unit 25 may comprise a (hydraulically, pneumatically or electrically actuated) hingeable gripper unit (which may be provided with a biasing means to permit the opening and closing of the gripper unit), one or more suction cups or other deformable load-bearing, gripping members that may be fixed to or detachable from the suspended aerial robotic device 110. Alternatively, the holder unit 25 may comprise an integral gripper unit (e.g. a hook) which may be fixed to or detachable from the suspended aerial robotic device 110. Further alternatively, the holder unit 25 may comprise one or more spaced apertures or one or more grooves formed in one or more surfaces of the suspended aerial robotic device 110. The skilled person will understand that the preferred embodiment is not limited to these holding means. On the contrary, these holding means are examples provided for explanatory purposes only. Instead, the skilled person will understand that the preferred embodiment is operable with any suitable means of holding one or more product items.

In addition to the receiver unit 28, the back-end module 14 may also comprise a repository 30 communicatively coupled with an order fulfilment unit 32 which is in turn communicatively coupled with a loading unit 34. The repository 30 is adapted to contain one or more product items (not shown), each of which may comprise a label to identify the relevant product item. The repository 30 may be a immobile facility (e.g. a building or a vending machine) or a mobile facility (e.g. a van stocked with items). The order fulfilment unit 32 is communicatively coupled with the receiver unit 28 to receive a communication comprising the identifiers of one or more product items requested by a customer.

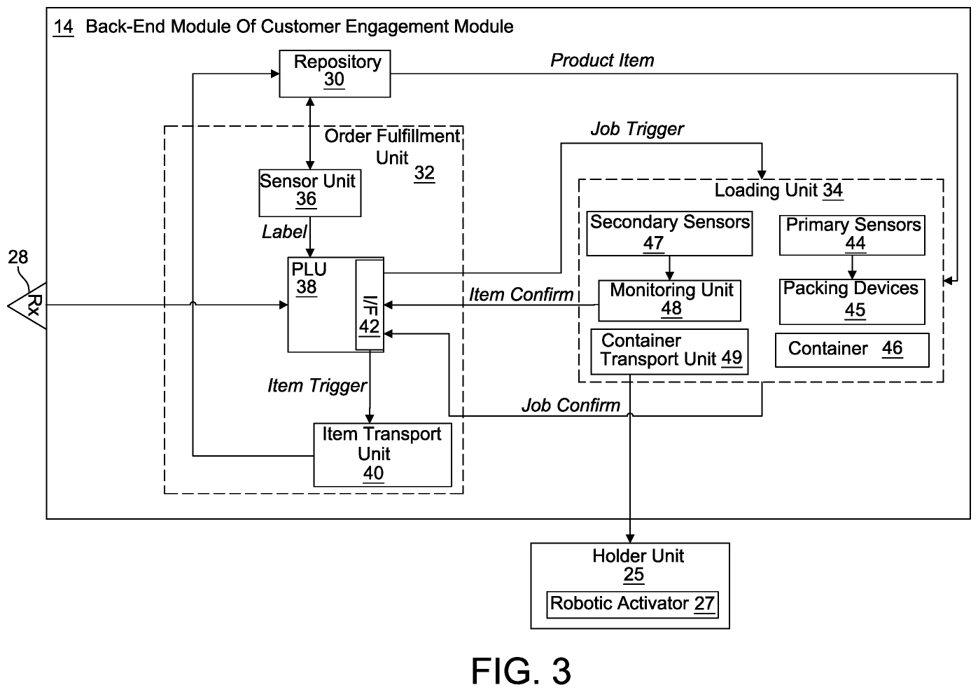

Referring to FIG. 3, the order fulfilment unit 32 may comprise a sensor unit 36, a programmable logic unit 38 and an item transport unit 40. The sensor unit 36 is adapted to detect and interrogate the label(s) (not shown) of the product i.e., stock items (not shown) in the repository 30; and to transmit information regarding the same to the programmable logic unit 38. The programmable logic unit 38 comprises a one or more bi-directional communications interfaces 42 through which it is communicatively coupled with the item transport unit 40 and the loading unit 34.

The programmable logic unit 38 is adapted to receive information from the sensor unit 36 regarding the labels detected by the sensor unit 36. The programmable logic unit 38 is further adapted to compare the received information with product item identifiers contained in the communication received by the order fulfilment module 32.

Through the bi-directional communications interface 42 the programmable logic unit 38 is adapted to issue one or more Item Trigger signals to the item transport unit 40 and to receive one more corresponding Item Confirmation signals from the loading unit 34. The bi-directional communications interface 42 is adapted to schedule the Item Trigger signals, such that subsequent, or successive, Item Trigger signals associated with multiple product items requested in a single customer communication, are not issued until receipt of an Item Confirmation signal corresponding with the previous Item Trigger signal. In this way, the item transport unit 40 is controlled to retrieve a first required product item and not to attempt to retrieve another product item until the retrieval of the first required product item has been completed.

The programmable logic unit 38 is adapted to issue an Item Trigger signal to the item transport unit 40 in the event information received from the sensor unit 36 regarding one or more detected labels matches an identifier in a communication received by the order fulfilment unit 32.

The item transport unit 40 may comprise a movable mechanical gripper means (e.g. a hook, a hinged gripper), a movable suction means or a conveyor belt and deflector. It will be acknowledged by persons skilled in the art that the preferred embodiment is not limited to these product transport means. On the contrary, these product transport means are examples provided for explanatory purposes only. Instead, persons skilled in the art will acknowledge that the preferred embodiment is operable with any suitable means of transporting product items.

On receipt of an Item Trigger signal from the programmable logic unit 38, the item transport unit 40 may be activated to retrieve a relevant product item from the repository 30 and transport the product item to the loading unit 34. The loading unit 34 may comprise a containment unit (not shown) which may comprise one or more containers 46 (e.g. tray, bag, box, or the like) and corresponding one or more packing devices 45. The loading unit 34 may comprise one or more primary sensors 44 disposed proximal to the containment unit. The primary sensors 44 may be adapted to issue a Product Proximity Activation signal (not shown) to the packing device 45 should a product item approach within a pre-configured distance of the containment unit.

On receipt of the Product Proximity Activation signal, the packing device 45 may be adapted to receive the product items from the item transport unit 40 and to place, stack or pack the received product items into one or more containers 46 (wherein the specific nature of the packing activity (e.g. packing, stacking or placing) depends on the nature of the items and/or the container). It will be acknowledged by persons skilled in the art that the preferred embodiment is not limited to these containers means and corresponding packing devices. On the contrary, these containers and packing devices are examples provided for explanatory purposes only. Instead, It will be acknowledged by persons skilled in the art that the preferred embodiment is operable with any suitable container for one or more product items and device for placing the product items into the container.

The loading unit 34 may further comprise one or more secondary sensors 47 disposed proximal to the container 46 and communicatively coupled with a monitoring unit 48 which is adapted to monitor the placing, stacking or packing of the product items onto or into the container 46. On detection (by the secondary sensors 47 and the monitoring unit 48) of the successful completion of the placing, and packing, of the product items into the containers 46, the monitoring unit 48 is adapted to issue an Item Confirmation signal to the programmable logic unit 38 (thereby indicating the successful retrieval of a required product item from the repository 30 and transport thereof to the loading unit 34).

The programmable logic unit 38 is adapted to issue a Job Trigger signal to the loading unit 34 on receipt of an Item Confirmation signal corresponding with the last identifier in the communication received by the order fulfilment module 32 that matches a label detected by the sensor unit 36 (i.e. thereby indicating that the last available product item corresponding to the order placed by the customer has been retrieved and packed).

Looking at FIG. 2 together with FIG. 1, depending on its current location in the volume 112, the suspended aerial robotic device 110 may be located remotely from the back-end module 14. For example, the suspended aerial robotic device 110 may travel to and fro, or in other words, shuttle between the front end module 12 and the respository 30 that forms part of the back end module 14. Thus, in this case, the navigation unit 24 may be required to navigate and move the suspended aerial robotic device 110 from its current location to the back-end module 14 to receive product items requested by the customer.

Now, looking at FIG. 1 together with FIG. 3, the loading unit 34 may further comprise a container transport unit 49 which comprises a means of transporting one or more containers 46, for example a moving arm or a conveyor belt etc. It will be acknowledged by persons skilled in the art that the preferred embodiment is not limited to these transport means. On the contrary, these transport means are examples provided for explanatory purposes only. Instead, the person skilled in the art will acknowledge that the preferred embodiment is operable with any suitable means of controllably transporting one or more (packed or unpacked) containers 46 from one location to another.

On receipt of a Job Trigger signal by the loading unit 34, the container transport unit 49 is adapted to transport one or more containers 46 containing product items requested by the customer to the holder unit 25 of the suspended aerial robotic device 110. On approaching the holder unit 25, the container transport unit 49 is adapted to release the one or more containers 46 to the holder unit 25 by one of the following mechanisms:

slide a tray into the grooves or one or more apertures formed in the surface of the suspended aerial robotic device 110; or

hang a bag onto a one-piece gripper unit of the holder unit 25; or

press a box or a tray onto one or more suction cups or deformable load-bearing, gripping members of the holder unit 25.

Alternatively, the holder unit 25 may comprise a proximity sensor (not shown) adapted to issue an activation trigger on detection of an object within a pre-defined distance from the holder unit 25. In this case, when the container transport unit 49 moves a container 46 sufficiently close to the holder unit 25 to cause the issuance of the activation trigger by the proximity sensor (not shown), one or more hingeable gripper units of the holder unit 25 are activated to releasably grab hold of the container 46 from the container transport unit 49. The container transport unit 49 is further adapted to issue a Job Confirmation signal to the programmable logic unit 38 on releasing the one or more containers 46 into the holder unit 25, thereby indicating that the one or more containers 46 containing the one or more items corresponding to the order placed by the customer has been handed over to the suspended aerial robotic device 110.

The holder unit 25 may comprise a robot activator 27 which is adapted to issue an activation signal (not shown) to the navigation system 24 on receipt of the one or more containers 46 by the holder unit 25, to thereby activate the navigation system 24 to cause the suspended aerial robotic device 110 to be moved and navigated back to the customer's location (or another configurable location as required).

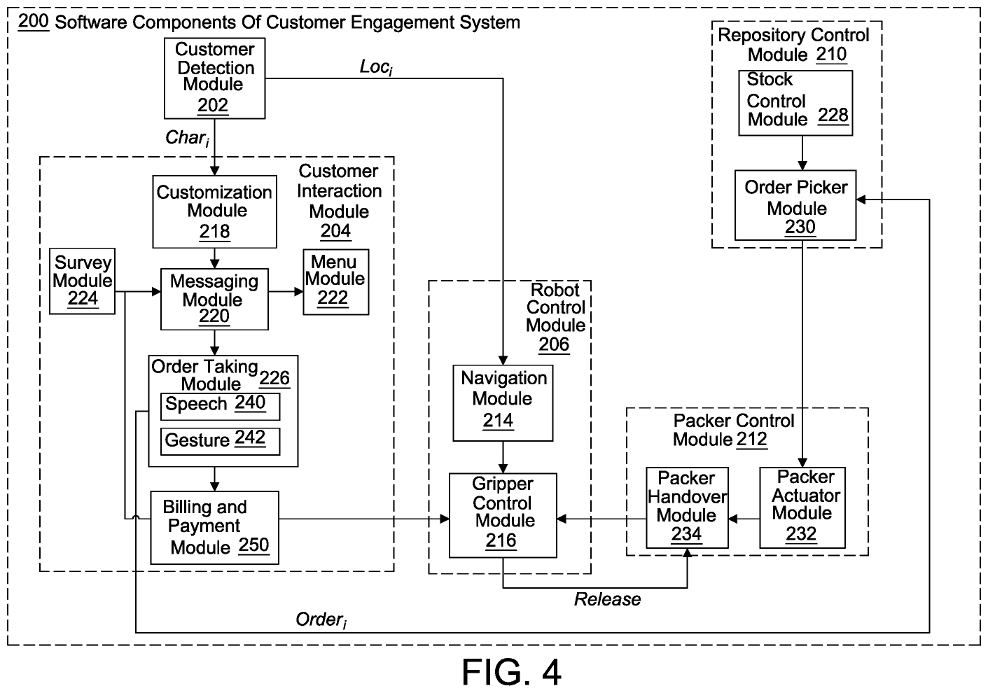

Referring to FIG. 4, the software components of the customer engagement system 200 comprise a customer detection module 202, customer interaction module 204, robot control module 206, repository control module 210 and a packer control module 212. The customer detection module 202 is communicatively coupled with the customer interaction module 204 and the robot control module 206. The customer interaction module 204 is communicatively coupled with the robot control module 206 and the repository control module 210. The repository control module 210 is communicatively coupled with the packer control module 212 which is in turn communicatively coupled with the robot control module 206.

Referring to FIG. 4 together with FIG. 1 and FIG. 2, the customer detection module 202 is adapted to process video information received from the sensors 18, to detect the entry of a customer into the volume 112. The customer detection module 202 comprises one or more object recognition algorithms and triangulation algorithms adapted to process the received video information to

to determine the location of the customer within the volume 112 (by potentially combining the received video information with additional triangulation video information acquired from one or more cameras mounted on the upright members 100); and

determine characteristics of the customer (e.g. gender, presence of a child, repeat customer, presence of flags, stickers or logos denoting customer interests or affiliations).

The customer detection module 202 is further adapted to communicate information regarding the customer's location (Locᵢ) to the robot control module 206; and the customer's characteristics (Charᵢ)to the customer interaction module 204.

The robot control module 206 comprises a navigation module 214 and a gripper control module 216. The navigation module 214 comprises one or more navigation algorithms which enables i.e., generates, outputs, or provides an optimal trajectory for the suspended aerial robotic device 110 within the volume 112 of the aerial host system 16 to be calculated to enable the suspended aerial robotic device 110 to be moved from a first location to a second location. The navigation module 214 may also include one or more obstacle avoidance algorithms which enable the optimal trajectory of the suspended aerial robotic device 110 to be modified to allow the suspended aerial robotic device 110 to avoid obstacles, fixed and moving, disposed between the first location and the second location. Using the algorithms, the navigation module 214 is adapted to receive the customer's location information (Locᵢ) from the customer detection module 202 and to activate the navigation system 24 to cause the suspended aerial robotic device 110 to be transported to the customer's location.

The customer interaction module 204 comprises a customisation module 218 communicatively coupled with a messaging module 220. The customisation module 218 comprises one or more customisation rules which are pre-configured by operators of the customer engagement system 200. The customisation module 218 is adapted to receive the customer's characteristics information (Charᵢ)from the customer detection module 202 and to use the customer's characteristics information (Charᵢ)together with the customisation rules to establish one or more configuration settings (and/or instructions) for the messaging module 220. The messaging module 220 operates the first communications unit 20 and the character masking unit 22 in accordance with the configuration settings (and/or instructions) received from the customer interaction module 204 (See FIG. 1).

For example, if the customer is accompanied by a young female child, the customisation module 218 is adapted to

establish instructions for the character masking unit 22 to present a female superhero persona for the suspended aerial robotic device 110

establish configuration settings for an age-appropriate vocabulary or a female voice for the messaging module 220.

Alternatively, if the customer is a repeat customer, the customisation module 218 is adapted to include the customer's name in the configuration settings for the messaging module 220.

It will be acknowledged by persons skilled in the art that the preferred embodiment is not limited to these scenarios and corresponding configuration settings/instructions. On the contrary, these scenarios are presented for illustration purposes only. Instead, the person skilled in the art will acknowledge that the preferred embodiment is operable with any suitable scenarios and corresponding configuration settings/instructions which requires touchless engagement with a customer.

The messaging module 220 is adapted to use the configuration settings received from the customisation module 218 to establish a communications persona (e.g., voice and/or vocabulary) for subsequent communications with the customer. To this end, the messaging module 220 may comprise one or more narrative rules pre-configured by the system operators wherein the one or more narrative rules establishes a narrative framework for subsequent communications with the customer. The relevant narrative framework depends on the specific use-case application requirements of the customer engagement system 200. For example, for use in a drive-through restaurant, the narrative framework may include a greeting, presentation of a menu, discussion of special offers, receiving an order, advising on waiting time for the order, advising of cost and requesting payment etc. Using the narrative rule/s and the configuration settings received from the customisation module 218, the messaging module 220 is adapted to co-ordinate, and execute, all subsequent communications with the customer.

With continued reference to FIGS. 1, 2 and 4, the messaging module 220 is further adapted to activate the speaker and/or the display unit in the first communications unit 20 and to communicate with the customer through the speaker and/or the display unit in accordance with the preconfigured narrative rule/s and the received configuration settings. Alternatively, the messaging module 220 may be adapted to use the antenna unit in the first communications unit 20 to allow the messaging module 220 to communicate with the customer through the customer's own cell phone or other wireless device.

Using the example of a drive-through restaurant, the customer interaction module 204 may comprise a menu module 222 which details all the food products available. Similarly, the customer interaction module 204 may comprise a survey module 224 adapted to conduct one or more surveys with the customer regarding their opinions regarding goods, services, newly released trial products etc. Persons skilled in the art will acknowledge that the preferred embodiment is not limited to these use cases. On the contrary, this use case is presented for illustration purposes only. Instead, the person skilled in the art will acknowledge that the preferred embodiment is operable with any suitable use case which requires touchless engagement with a customer.

The customer interaction module 204 may further comprise an order taking module 226 adapted to communicate with the first communications unit 20 to receive an order placed by the customer. To this end, the order taking module 226 is adapted to receive audio signals arising from customer utterances from the microphone (not shown) in the first communications unit 20 or from the customer's own cell phone or other wireless device (not shown) by way of the antenna unit in the first communications unit 20. The customer interaction module 204 comprises speech recognition and language processing algorithms 240 adapted to recognize and comprehend audible utterances and instructions from the customer in the received audio signals.

Examples of suitable speech recognition algorithms include hidden Markov modelling, dynamic time warping (DTW) based speech recognition methods and deep neural networks and denoising autoencoders. Persons skilled in the art will acknowledge that the preferred embodiment is not limited to these speech recognition algorithms. Rather, these examples of algorithms are provided for illustration purposes only. Accordingly, the person skilled in the art will acknowledge that the preferred embodiment is operable with any suitable speech recognition and language processing algorithm which permits the messaging module 220 to recognize and comprehend audible utterances and instructions from the customer.

With continued reference to FIGS. 1, 2 and 4, the order taking module 226 is further adapted to receive video footage of customer gestures from the sensors 18 in the front-end module 12 and/or from one or more cameras mounted on the upright members 100. The order taking module 226 also comprises gesture recognition algorithms 242 adapted to recognize and comprehend gestures from the customer in the received video footage. Examples of suitable gesture recognition algorithms include skeletal-based algorithms and appearance-based algorithms. It will be acknowledged by persons skilled in the art that the preferred embodiment is not limited to these gesture recognition algorithms. On the contrary, these examples of algorithms are provided for illustration purposes only. Indeed, the person skilled in the art will acknowledge that the preferred embodiment is operable with any suitable gesture recognition which permits the messaging module 220 to recognize gestural instructions from the customer.

Using at least one of the speech recognition and language processing algorithms 240 and the gesture recognition algorithms 242, the order taking module 226 is adapted to receive an order for goods (e.g. food in the drive-through restaurant example) from the customer. The order taking module 226 is further adapted to communicate information regarding the customer's order to the repository control module 210. For brevity, the information regarding the customer's order will be referred to henceforth as Customer Order Information (Orderᵢ). Similarly, individual product items in a customer's order will be referred to henceforth as Required Product Items (Itemⱼ).

The repository control module 210 comprises a stock control module 228 and an order picker module 230. The repository control module 210 is adapted to receive Customer Order Information (Orderᵢ)and on receipt of the same, to activate the stock control module 228. On activation, the stock control module 228 is adapted to activate the sensor unit 36 and the programmable logic unit 38 in the order fulfilment unit 32 (see FIG. 3), to interrogate the repository 30 to determine if the Required Product Items (Itemⱼ) are contained in the repository 30. The stock control module 228 is further adapted to advise the operators should the remaining stocks fall below a pre-defined threshold, so that further stocks of the product item can be re-ordered as appropriate.

In the event the Required Product Items (Itemⱼ) are contained in the repository 30, the stock control module 228 activates the order picker module 230. The order picker module 230 activates the programmable logic unit 38 to issue one or more Item Trigger signals to the transport unit 40 to thereby retrieve the Required Product Items (Itemⱼ) from the repository 30 and transport the Required Product Items (Itemⱼ) to the loading unit 34.

Referring to FIG. 4 together with FIG. 3, the loading unit 34 operates under the control of the packer control module 212. The packer control module 212 comprises a packer actuator module 232 and a packer handover module 234. On receipt of an Item Trigger signal and a Product Proximity Activation signal (from the primary sensors 44), the packer actuator module 232 is adapted to activate the packing devices 45 in the loading module 34 to pack the Required Product Item (Itemⱼ) into the container 46. The Packer Actuator Module 232 is further adapted to communicate with the secondary sensors 47 and the monitoring unit 48 to monitor the progress of the packing operations and to correct the movements of the transport module 40 and the packing devices 45 if needed to ensure efficient packing of the Required Product Item (Itemⱼ) into the container 46.

The navigation module 214 is adapted to activate the navigation system 24 to cause the suspended aerial robotic device 110 to be transported to a location proximal to the loading unit 34. On receipt of a Job Trigger signal (i.e. indicating that all the available product items ordered by the customer have been packed into the one or more containers 46), the packer handover module 234 is adapted to control the movements of the container transport unit 49 to cause the packed container 46 to be transported to the holder unit 25 and released into its safekeeping. For example, a holder unit 25 comprising a hingeable gripper unit operates under the control of the gripper control module 216. The gripper control module 216 is adapted to activate the hingeable gripper unit on receipt of the container 46 from the container transport unit 49. On activation, the hingeable gripper unit closes around the container 46 and issues a Release signal to the packer handover module 234. On receipt of the Release signal, the packer handover module 234 is adapted to trigger the container transport unit 49 into releasing the container 46. On receipt of the container 46, the robot activator 27 is adapted to issue an activation signal to the navigation system 24, upon which the navigation module 214 is adapted to activate the navigation system 24 to cause the suspended aerial robotic device 110 to be transported back to the customer's location (Locᵢ) (or other location as required).

On return of the suspended aerial robotic device 110 to the customer's location (Locᵢ), a billing and payment module 250 is activated together with the messaging module 220 to operate

the first communications unit 20 to advise the customer of the bill and request the customer to present their payment card (or one or more radio-frequency or near field communication enabled payment devices (e.g., smart fobs, smart cards, cell phones or other wireless devices) to the contactless card reader 29 (or radio frequency tag reader or a near field tag reader); and

the contactless card reader 29 (or radio frequency tag reader or a near field tag reader) to receive payment from the customer through their payment card or other radio-frequency or near field communication enabled payment device.

On receipt of payment, the gripper control module 216 is adapted to activate the holder unit 25 to release the container 46, containing the one or more retrieved items, to the customer.

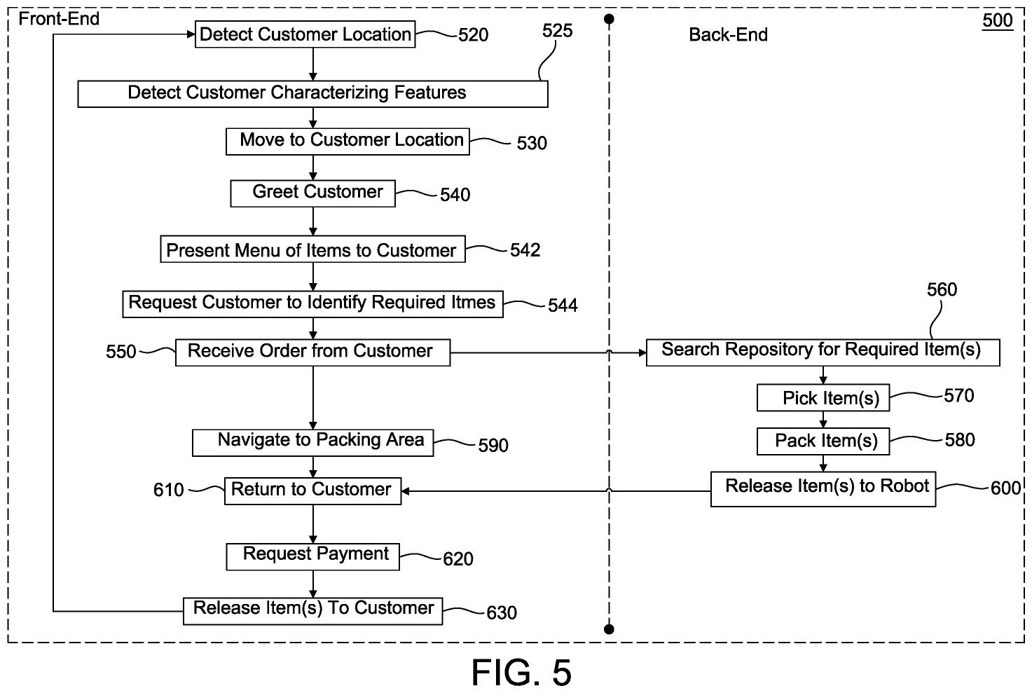

Referring to FIG. 5, the customer engagement method 500 of the preferred embodiment comprises the step of detecting 520 the location of the customer. The method 500 also includes the step of detecting 525 one or more characterizing features of the customer. The method 500 further includes the step of moving 530 the suspended aerial robotic device 110 to the detected customer location. The method 500 further includes the step of greeting 540 the customer in accordance with the one or more customer characteristics. The method 500 further includes the step of presenting 542 a menu of items to the customer and requesting 544 the customer to identify product items of interest from the menu.

The method 500 further includes the step of receiving 550 from the customer, an order placed towards one or more items.

The method 500 further includes the step of retrieving the items corresponding to the placed order from the repository 30. As shown, this step includes searching 560 the back-end repository 30 for the required item (s). The step of retrieving the items corresponding to the placed order from the repository 30 includes the step of picking 570 from the back-end repository 30 the required item(s) contained in the back-end repository 30. Further, this step of retreiving also includes the step of packing 580 the retrieved item(s) i.e., item(s) picked from the respository 30 into the container 46 at a packing location.

Further, the method 500 further includes the step of moving 590 the suspended aerial robotic device 110 to the packing location. In addition, the step of retreiving also includes the step of releasing 600 the container 46 to the suspended aerial robotic device 110 following the step of packing 580.

The method 500 further includes the step of returning 610 the suspended aerial robotic device 110 to the detected customer location. The method 500 further includes the step of requesting 620 touchless payment from the customer for the placed order. The method 500 further includes the step of releasing 630 the retrieved stock item(s) to the customer on receipt of touchless payment from the customer for the order. Upon completion of this step, the method 500 returns to step 520 to detect a subsequent customer's location.

The step of detecting 520 the location of the customer in the observed area to establish the detected customer location is performed by triangulation from video information acquired by the plurality of video sensors 18. Alternatively, the detected customer location is determined by the suspended aerial robotic device 110 from video footage captured by the suspended aerial robotic device.

The step of detecting 525 one or more characterizing features of the customer employs a plurality of computer vision algorithms (and more preferably machine learning algorithms) to detect

the gender of the customer;

the presence of a child accompanying the customer (and estimate the age and gender of the child);

a customer who is a repeat customer (and potentially the identity of the customer); and

the presence of flags, stickers or logos on the customer's clothing (or that of an accompanying person) or on the customer's car etc. denoting particular customer interests or affiliations (e.g. supporter of a particular football club etc.)

The step of moving 530 the suspended aerial robotic device 110 to the detected customer location employs navigation algorithms adapted to calculate an optimal trajectory for the suspended aerial robotic device 110 from a first location to a second location. The step of moving 530 the suspended aerial robotic device 110 to the detected customer location may also employ obstacle avoidance algorithms adapted to adjust the optimal trajectory to allow the suspended aerial robotic device 110 to avoid fixed or moving obstacles between the first and second locations.

The step of greeting 540 the customer in accordance with the detected customer characteristics include:

using the detected customer characteristics to predict likely visual preferences of the customer or an accompanying person (e.g. a female avatar for a female customer) and altering the appearance of the suspended aerial robotic device 110 to match the visual preferences (e.g. so that the suspended aerial robotic device 110 takes the appearance of a super-hero or a cartoon character etc.);

establishing age-appropriate and culturally appropriate vocabulary for the suspended aerial robotic device 110.

Altering the appearance of the suspended aerial robotic device 110 to match predicted visual preferences of the customer and/or an accompanying person may include the steps of using the projection apparatus mounted on the suspended aerial robotic device 110 to display the avatar with the required appearance. Alternatively, a physical representation of the required appearance may be provided by selecting a toy or an action figure of a relevant character and mounting the toy or action figure on or around the suspended aerial robotic device 110.

The steps of presenting 542 the menu of items to the customer and requesting 544 the customer to identify product items of interest may comprise the steps of using the pre-configured narrative framework to present the customer with the menu with a view to ordering product items or to undertake other activities (e.g. customer survey) with the customer. The menu may be presented on a display unit mounted on the suspended aerial robotic device 110. Alternatively, the step 542 may comprise the steps of using the antenna unit to transmit the menu to the customer's own cell phone or other wireless device and instructing the cell phone or other wireless device to display the menu to the customer. Further alternatively, the step 542 may comprise using one or more speakers mounted on the suspended aerial robotic device 110 and coupled with one or more speech generating algorithms using the previously determined age and culturally appropriate vocabulary to verbally recite the menu to the customer. These steps 542, 544 may also include presenting special offers to the customer for their consideration.

The step of receiving 550 from the customer, an order placed towards one or more items comprises the steps of using a microphone mounted on the suspended aerial robotic device 110 to detect sounds from the customer and using speech recognition and language processing algorithms to recognise and comprehend audible utterances and instructions from the customer in the detected sounds. Alternatively, the step 550 may comprise using video sensors 18 mounted on the suspended aerial robotic device 110 to detect movements of the customer and using gesture recognition algorithms to interpret the detected movements to identify the gestures performed by the customer denoting the selection of particular items from the menu.

The method 500 includes a further step of transmitting the received order to a back-end processing element including the repository 30 of product items and a queued packing element; and wherein the back-end processing element may be located remotely from the customer.

The step of retrieving 570 the stock item(s) from the back-end repository 30 comprises the steps of using computer vision algorithms together with scanning devices or other suitable sensors to read the labels of goods in the repository to determine if any of the labels match one or more identifiers of the required item(s). In the event of a match, the method 500 retrieves the item(s) i.e., stock item(s) from the repository 30. In the process of selecting item(s) from the repository 30, the method 500 may include issuing a warning to the operators in an event of stocks of particular goods being lower than one or more acceptable pre-defined thresholds.

The step of packing 580 the retrieved item(s) in the container 46 may comprise the steps of packing the retrieved item(s) into a bag or a box, or stacking the retrieved item(s) onto a tray. This step 580 is followed by surrendering, or releasing 600, the bag, box, tray or another vessel containing the retrieved item(s) to the holder unit 25 of the suspended aerial robotic device 110. For example, this step 600 could include sliding the tray holding the retrieved item(s) into grooves formed in the face of the suspended aerial robotic device 110. Alternatively, the step 600 could include hanging the bag containing the retrieved item(s) on the hook/peg or within a clip mounted on the suspended aerial robotic device 110. Further alternatively, the step 600 could include placing the box or bag containing the retrieved item(s) into an active gripping member (e.g. an actuatable hinged gripping hand).

The step of requesting 620 payment from the customer, for the retrieved item(s) comprises the step of calculating the total cost of the retrieved item(s) and requesting the customer to provide touchless payment for the total cost using the touchless, or contactless, card reader 29 mounted on the suspended aerial robotic device 110.

While retrieving the required product item(s) from the repository and packing them into the container(s) 46, the method 500 may, additionally, or optionally, include a step of undertaking a survey with the customer. Alternatively, the step of undertaking the survey may be performed after releasing the retrieved required product item(s).

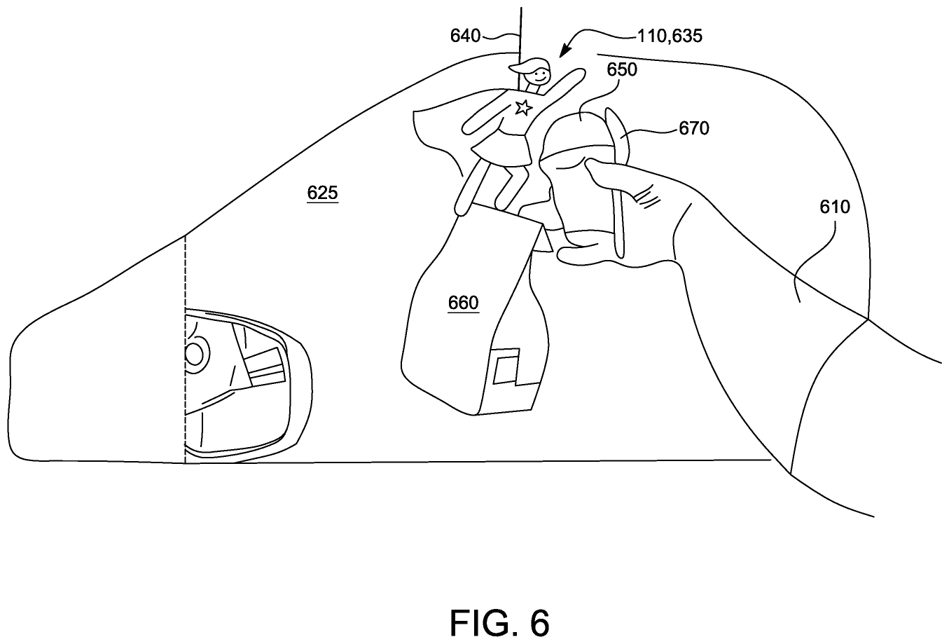

FIG. 6 shows a use case example of a drive through restaurant, wherein a customer 610 opens a side window 625 of a car (not shown) to speak to a superhero avatar 635 projected around or mounted around the suspended aerial robotic device 110 (hereinafter also denoted using reference numeral ‘635’) suspended from an overhead wire 640. On receipt of the order from the customer 610, the suspended aerial robotic device 110, 635 retrieves the ordered items (in this example, an ice-cream 650 and bagged burger and/or fries 660) and eating utensils (e.g. a spoon) 670 as needed; and on receipt of payment from the customer, releases the ordered items into the hands of the customer 610.

Modifications and alterations may be made to the above disclosure without deviating from the spirit of the present disclosure. Moreover, modifications to embodiments of the present disclosure described in the foregoing are possible without departing from the scope of the present disclosure as defined by the accompanying claims. Expressions such as “including”, “comprising”, “incorporating”, “providing”, “consisting of” or “have” are used to describe the present disclosure and are to be construed in a non-exclusive manner, namely allowing for items, components or elements not explicitly described also to be present. Reference to the singular is also to be construed to relate to the plural wherever the context so applies.

1. A customer engagement method comprising the steps of
detecting a location of a customer;
detecting one or more characterizing features of the customer;
moving a suspended aerial robotic device to the customer's location;
greeting the customer in accordance with the one or more characterizing features;
presenting a menu of items to the customer;
requesting the customer to identify items of interest from the menu;
receiving from the customer an order placed towards one or more items;
retrieving the items corresponding to the placed order from a repository containing stock items;
releasing the retrieved stock items to the suspended aerial robotic device;
requesting touchless payment from the customer for the placed order; and
releasing the retrieved stock items to the customer on receipt of touchless payment by the customer for the order; wherein the suspended aerial robotic device performs the steps of:
greeting the customer,
receiving the order from the customer,
requesting the touchless payment from the customer, and
releasing the items to the customer.

2. The customer engagement method of claim 1, wherein the step of detecting the location of the customer comprises the step of detecting the location of the customer from either or both of:
triangulation from video information acquired by one or more video sensors; and
video footage captured by the suspended aerial robotic device.

3. The customer engagement method of claim 1, wherein the one or more characterizing features of the customer are selected from a group consisting of:
a gender of the customer;
a presence of a child accompanying the customer;
an identifier of a customer who is a repeat customer; and
a presence of flags, stickers or logos on the customer's clothing or vehicle denoting customer interests or affiliations.

4. The customer engagement method of claim 1, wherein the step of moving the suspended aerial robotic device to the customer's location comprises the step of using:
one or more navigation algorithms to calculate an optimal trajectory for the suspended aerial robotic device from a first location to a second location; and
one or more obstacle avoidance algorithms to adjust the optimal trajectory to allow the suspended aerial robotic device to avoid fixed or moving obstacles between the first and second locations.

5. The customer engagement method of claim 1, wherein the step of greeting the customer in accordance with their one or more characterizing features comprises the steps of:
using characterizing features to predict one or more visual preference attributes of the customer;
altering an appearance of the suspended aerial robotic device to match the one or more predicted visual preference attributes; and
establishing age and culturally appropriate vocabulary for the suspended aerial robotic device.

6. The customer engagement method of claim 5, wherein the step of altering the appearance of the suspended aerial robotic device to match the predicted one or more visual preference attributes comprises the steps of:
mounting a projection apparatus on the suspended aerial robotic device; and
using the projection apparatus to display an avatar on the suspended aerial robotic device whose appearance corresponds to the predicted one or more visual preference attribute.

7. The customer engagement method of claim 1, wherein the step of presenting a menu of items to the customer comprises one or more of the steps of:
presenting the menu on a display unit mounted on the suspended aerial robotic device;
using one or more speaker devices mounted on the suspended aerial robotic device and one or more speech generating algorithms configured with age and culturally appropriate vocabulary for enabling the one or more speaker devices to verbally recite the menu to the customer; and
transmitting the menu to a customer cell phone or other wireless device; and
instructing the customer cell phone or other wireless device to display the menu to the customer.

8. The customer engagement method of claim 1, wherein the step of requesting the customer to identify product items of interest from the menu comprises using a pre-configured narrative framework for ordering items or undertaking other activities which require a selection activity to be performed by the customer.

9. The customer engagement method of claim 1, wherein the step of receiving the order from the customer comprises detecting one or more identifiers of the one or more items placed in the order using one of:
one or more microphones mounted on the suspended aerial robotic device to detect sounds from the customer and one or more speech recognition and language processing algorithms selected from a group consisting of hidden Markov modelling, dynamic time warping (DTW) based speech recognition methods, deep neural networks, and denoising autoencoders to recognize and comprehend audible utterances and instructions from the customer in the detected sounds; and
one or more video sensors mounted on the suspended aerial robotic device to detect movements of the customer and one or more gesture recognition algorithms selected from a group consisting of skeletal-based algorithms and appearance-based algorithms to interpret the detected movements to identify gestures performed by the customer denoting a selection of items from the menu.

10. The customer engagement method of claim 9, wherein the step of retrieving the one or more items corresponding to the placed order from the repository comprises
using one or more scanning devices in the repository and one or more computer vision algorithms operable with the one or more scanning devices to:
read labels of the stock items contained in the repository;
compare the labels of the stock items in the repository with the detected identifiers of the items in the order placed by the customer; and
extract stock items from the repository in an event of a match between the labels of the stock items and the detected identifiers of the items in the order.

11. The customer engagement method of claim 1, wherein the step of requesting touchless payment from the customer for the placed order is preceded by the steps of
moving the suspended aerial robotic device to a packing location;
packing the retrieved stock items into one or more containers at the packing location;
releasing the one or more containers to the suspended aerial robotic device; and
returning the suspended aerial robotic device to the customer's location with the one or more containers containing the stock items retrieved corresponding to the placed order.

12. The customer engagement method of claim 1, wherein the step of requesting touchless payment from the customer for the placed order comprises requesting the customer to present their payment card having one or more radio-frequency or near field communication enabled payment devices selected from a group consisting of smart fobs, smart cards, cell phones or other wireless devices having digital wallets to a contactless card reader mounted using one of a radio frequency tag reader or a near field tag reader on the suspended aerial robotic device adapted to read payment cards.

13. A customer engagement system comprising:
a customer detection module adapted to process video information received from one or more sensors to determine a location of a customer and detect one or more characterizing features of the customer;
a customer interaction module adapted to use the characterizing features to create a customized greeting message and issue the greeting message to the customer;
an order taking module adapted to receive from the customer an order placed by the customer for one or more items;
a repository control module adapted to retrieve the one or more items corresponding to the placed order from a repository of stock items;
a billing and payment module adapted to request the customer for payment for the placed order and to use a contactless card reader unit to receive the payment from the customer
a gripping means adapted to hold one or more stock items retrieved by the repository control module and release the retrieved one or more stock items to the customer on receipt of contactless payment; wherein
the customer interaction module, the order taking module, the billing and payment module and the gripping means are operable by a suspended aerial robotic device movable to:
a customer location to receive the customer order,
the repository to pick up the one or more stock items retrieved by the repository control module;
return to the customer location to receive payment for the placed order; and
release the picked up one or more stock items corresponding to the placed order to the customer.

14. The customer engagement system of claim 13, wherein the suspended aerial robotic device comprises:
one or more navigation algorithms adapted to calculate an optimal trajectory for a movement of the suspended aerial robotic device from a first location to a second location; and
one or more obstacle avoidance algorithms adapted to modify the optimal trajectory to allow the suspended aerial robotic device to avoid obstacles between the first and second locations.

15. The customer engagement system of claim 13, wherein the suspended aerial robotic device comprises one or more sensors and the customer detection module operable by the suspended aerial robotic device comprises:
one or more object recognition algorithms and triangulation algorithms adapted to process video information received from the one or more sensors; and
a plurality of computer vision algorithms adapted to detect one or more characterizing features selected from a group consisting of:
a gender of the customer;
a presence of a child accompanying the customer;
an identifier of the customer if the customer is a repeat customer; and
a presence of flags, stickers or logos on the customer's clothing or vehicle denoting customer interests or affiliations.

16. The customer engagement system of claim 13, wherein the suspended aerial robotic device comprises one or more speakers and a display unit, and wherein the customer interaction module operable by the suspended aerial robotic device is adapted to use at least one of the speakers or the display unit to:
issue the greeting message to the customer,
present the menu to the customer, and
request the customer to identify items of interest from a menu.

17. The customer engagement system of claim 16, wherein the customer interaction module is adapted to use the detected characterizing features to establish an age and/or culturally appropriate vocabulary for communications with the customer with one or more pre-configured narrative rules to co-ordinate communications with the customer, and wherein the order taking module comprises one or more speech generating algorithms configurable with the age and/or culturally appropriate vocabulary for verbally reciting the menu to the customer via one of: the one or more speakers and the display unit on the suspended aerial robotic device.

18. The customer engagement system of claim 13, wherein the customer interaction module is adapted to use the detected characterizing features to predict one or more visual preference attributes of the customer, and wherein the robotic aerial device is provided with a character masking unit adapted to alter an appearance of the suspended aerial robotic device to match the predicted one or more visual preference attributes.

19. The customer engagement system of claim 13 further comprising a character masking unit that comprises at least one of:
a physical model of a popular character from an animation, movie, computer game or a comic-book character and the character masking unit is adapted to mount the physical model on or around the suspended aerial robotic device; and
a projector unit adapted to display an avatar of a popular character from an animation, movie, and computer game or as a comic-book character on the suspended aerial robotic device.

20. The customer engagement system of claim 13, wherein the order taking module is adapted to:
transmit a menu to a customer cell phone or other wireless device, and
instruct the customer cell phone or other wireless device to display the menu to the customer.

21. The customer engagement system of claim 13, wherein the suspended aerial robotic device is provided with one or more microphone devices to detect sounds from the customer; and the order taking module detects identifiers of the items ordered by the customer by at least one of:
recognizing and comprehending audible utterances and instructions from the customer in the detected sounds using one or more speech recognition and language processing algorithms selected from a group consisting of hidden Markov modelling, dynamic time warping (DTW) based speech recognition methods and deep neural networks and denoising autoencoders; and
identifying gestures performed by the customer denoting a selection of items from a menu using one or more one or more gesture recognition algorithms adapted to interpret customer movements detected by the one or more sensors mounted on the suspended aerial robotic device.

22. The customer engagement system of claim 13, wherein the repository control module is adapted to use one or more computer vision algorithms to:
operate one or more scanning devices to read labels of the stock items contained in the repository;
compare the labels of the stock items contained in the repository with detected identifiers of items order placed by the customer; and
extract stock items from the repository in an event of a match between the labels of the stock items and the detected identifiers of the items in the order.

23. The customer engagement system of claim 13 further comprising a packing device adapted to pack the one or more stock items retrieved from the repository into one or more containers, and wherein the suspended aerial robotic device is adapted to move to the packing device to retrieve the one or more containers and return to the customer location for releasing the one or more containers to the customer.

24. The customer engagement system of claim 13, wherein the suspended aerial robotic device comprises a contactless card reader unit and the billing and payment module is adapted to use speakers or a display unit mounted on the suspended aerial robotic device to request the customer to present their payment card to the contactless card reader unit to make payment of the bill towards their placed order.

25. A non-transitory computer readable medium having stored thereon computer-executable instructions which, when executed by a processor, cause the processor to:
move a suspended aerial robotic device to a customer's location;
cause the suspended aerial robotic device to:
detect the location of the customer and one or more characterizing features of the customer,
greet the customer in accordance with the one or more characterizing features,
present a menu of items to the customer,
request the customer to identify items of interest from the menu,
receive from the customer an order placed towards one or more items,
cause a repository control module to retrieve the items corresponding to the placed order from a repository containing stock items; and
cause the suspended aerial robotic device to:
pick up one or more stock items retrieved by the repository control module and return with the picked up one or more stock items to the customer's location,
request touchless payment from the customer for the placed order, and
release the items to the customer on receipt of touchless payment by the customer for the order.
